(19) United States
(12) Patent Application Publication
(10) Pub. No.: US 2020/0237592 A1
(43) Pub. Date: Jul. 30, 2020

(54) LIFTING SEAT

(71) Applicant: Yen Ching CHU, Cupertino, CA (US)

(72) Inventor: Yen Ching CHU, Cupertino, CA (US)

(21) Appl. No.: 16/776,111

(22) Filed: Jan. 29, 2020

(30) Foreign Application Priority Data
Jan. 29, 2019 (TW) 108201378

(51) Int. Cl. A61G 5/14; A47C 7/56

(52) U.S. Cl. CPC A61G 5/14; A47C 7/566

(57) ABSTRACT

The invention discloses a lifting seat, which has an upper cushion assembly, a lower cushion assembly, an elastic member and an adjustment structure. One end of the upper cushion assembly is rotatably connected with one end of the lower cushion assembly, and the elastic member is arranged between the upper cushion assembly and the lower cushion assembly; wherein, the upper cushion assembly and the lower cushion assembly rotate relatively to have an open state and a closed state. The elastic member is in compression state when it is closed, and the adjustment structure is used to change the torque of the upper cushion assembly to the elastic member when it is open and closed. The technical solution provided by the invention can solve the problem that the existing lifting seat cannot fully satisfy the user's sit-to-stand requirements.

### CROSS-REFERENCE TO RELATED APPLICATIONS

This application claims priority to Taiwan Patent Application No. 108201378, filed on Jan. 29, 2019, now pending, which is hereby incorporated by reference in its entirety.

Although incorporated by reference in its entirety, no arguments or disclaimers made in the related application apply to this application. Any disclaimer that may have and occurred or might occur during the prosecution of the above-referenced application is hereby expressly rescinded.

### FIELD OF THE DISCLOSURE

The disclosed invention is related to the technical field of lift assisted machinery, in particular to a sit-to-stand lift assisted seat cushion.

### BACKGROUND OF THE DISCLOSURE

Getting up from the chair is the first requirement for a person to live independently. Sitting down and standing up motion are high risk movements for the elderly or patients with physical impaired. Therefore, the elderly or patients often need extra things to help them sit down and stand up, and they often have a “fall down” situation in the process of sitting down. In addition to the decline of the muscles of the legs in the elderly, the reduced trunk leaning angle and the leg backward movement speed in the early stage of standing-up from sitting makes them difficult to stand up from a chair. Therefore, it is necessary to provide a kind of cushion or seat with spring that can be used in daily life at home, to slow down the speed of the trunk descending when sitting down and to provide up-lift thrust pushing the trunk up when standing-up.

All the prior arts consist of a cushion. By placing springs under the cushions, the user can use the spring force to slow down the trunk falling speed when sitting down, and use the same spring to off-load part of the lifting forced required when standing up.

However, the effective spring tension of the existing lifting seat cushion is less than the trunk sitting weight when the seat is sit. For users to stand up from the seat, they need use leg muscle to raise the trunk up to stand up from the seat. The lifting assistance provided by the lift seat cushion to users is very limited, cannot meet the complete requirements to the user.

In view of this, the inventor specially studies the sit-to-stand movements and improves the cushion to improve the shortages on the prior arts with a better design. After a long period of research and development and continuous testing, the invention came into being.

### BRIEF SUMMARY OF THE DISCLOSURE

In view of this, the objective of this innovation is to design a lifting seat.

Based on the above objective, the invention provides a lifting seat cushion, which includes an upper cushion assembly, a lower cushion assembly, an elastic member and an adjustment structure. One end of the upper cushion assembly is rotatably connected with one end of the lower cushion assembly, and the elastic member is arranged between the upper cushion assembly and the lower cushion assembly; wherein, the upper cushion assembly and the lower cushion assembly rotate relative to each other. There are open state and closed states. The elastic member is in compression state when it is in closed state. The adjustment structure is used to change the torque of the upper cushion assembly to the elastic member when the upper cushion assembly is in open state and closed state.

Further, the upper cushion assembly includes an upper plate and an upper cushion. The upper plate has a first end and a second end which are relatively arranged. The first end of the upper plate and the lower cushion assembly can be rotatably connected. The elastic member is arranged between the upper plate and the lower cushion assembly. The upper cushion is arranged on the side which is far away from the lower cushion assembly of the upper plate. The upper cushion can slide between the second end and the second end relative to the upper plate.

Further, the adjustment structure includes a guide slot and a guide rod, the guide slot is arranged on the upper plate, and the guide slot extends along the first end to the second end of the upper plate, one end of the guide rod is connected with the upper cushion, and the other end of the guide rod can be slidably arranged in the guide slot.

Further, the adjustment structure includes a plurality of guide slots and a plurality of guide rods, wherein a plurality of guide slots are arranged on the upper plate in parallel with each other, and a plurality of guide slots and a plurality of guide rods are arranged in one-to-one correspondence.

Further, the adjustment structure also includes a rolling element, which is arranged between the upper plate and the upper cushion, and is used to reduce the friction force between the upper cushion and the upper plate sliding.

Further, the elastic member includes a wrap spring, which has a relatively arranged upper wrap spring arm and a lower wrap spring arm. The upper cushion assembly and the lower cushion assembly are connected by a rotating shaft. The wrap spring is wrapped on the rotating shaft loosely, and the upper wrap spring arm is butted with the upper cushion assembly, and the lower wrap spring arm is butted with the lower cushion assembly.

Further, the lower cushion assembly includes a lower plate and a lower cushion, the lower plate or the lower cushion is connected with the first end of the upper plate through a rotating shaft, the lower cushion is fixedly connected with the lower plate, and the lower cushion is located on the side of the lower plate far away from the upper plate.

Further, the lifting seat cushion also includes an upper connecting piece and a lower connecting piece, the upper connecting piece includes an interconnected upper connecting plate and an upper rotating arm with holes, the upper rotating arm is located on both sides of the upper connecting plate, the upper connecting plate is connected with the first end of the upper plate, the lower connecting piece includes an interconnected lower connecting plate and a lower rotating arm with holes, the lower rotating arm is located on both sides of the lower connecting plate, and the lower connecting plate is connected with the lower plate, and the rotating shaft passes through the hole on the upper rotating arm, the hole on the lower rotating arm and the shaft hole of the wrap spring, so that the upper plate and the lower plate can be rotatably connected.

Further, the lifting seat cushion also includes a fixing plate, which is connected with the lower plate, and the fixing plate has a avoidance groove, the lower wrap spring arm is penetrated in the avoidance groove, and the lower wrap spring arm is fixed on the lower plate through the fixing plate.

Further, the lower plate and the lower cushion are of a split structure, and the material of the lower plate is different from that of the lower cushion.

It can be seen from the above that the lifting seat cushion provided by this innovation includes upper cushion assembly, lower cushion assembly, elastic member and adjustment structure. Among them, the upper cushion assembly and the lower cushion assembly can be rotationally connected. The elastic member is located between the upper cushion assembly and the lower cushion assembly. Through the elastic member, the upper cushion assembly and the lower cushion assembly can be in the open state. Through adjustment the structure, the torque of the upper cushion assembly to the elastic member is different in the open state and the closed state. In use, when the user sits down, he can overcome the elastic force of the elastic member by trunk weight gravity to close the upper cushion assembly and the lower cushion assembly, so that the user can sit down slowly. Upon standing up, the trunk weight torque of the upper cushion assembly to the elastic member can be reduced by using the adjustment structure, so that the torque on the pre-loaded compressed elastic member to the upper cushion assembly is greater than the reduced weight torque generated by the adjustment structure, and then the upper cushion assembly can be pushed open by the elastic member to assist the user in getting up. This makes it easy for the user to sit down and stand up without any auxiliary tools, reduces the risk of falling and injury when the user gets up, and meets the user's sitting up needs

### BRIEF DESCRIPTION OF THE DRAWINGS

FIG. 1 is the structural diagram of the lifting seat cushion provided by the embodiment of the invention;

FIG. 2 is the front view of the lifting seat cushion provided by the embodiment of the invention;

FIG. 3 is a schematic diagram of the lifting seat cushion in the closed state provided by the invention embodiment; and

FIG. 4 is the schematic diagram of the lifting seat cushion in the closed state and the upper seat moves forward relative to the upper plate provided by the embodiment of the invention.

### DETAILED DESCRIPTION OF THE EMBODIMENTS

This innovation is a kind of lifting seat cushion. Its implementation means, characteristics and efficacy are described in detail below with several prefer and feasible examples, so as to provide an in-depth understanding and recognition of this innovation.

In order to make the objective, technical scheme and advantages of the invention clearer, the invention will be further described in detail with reference to the specific embodiments and the attached drawings

It should be noted that all the expressions of “first” and “second” in the creation embodiment are used to distinguish two entities with the same name or different parameters. It can be seen that “first” and “second” are only for the convenience of expression, and should not be understood as the limitation of the creation embodiment, which will not be explained in the following embodiments.

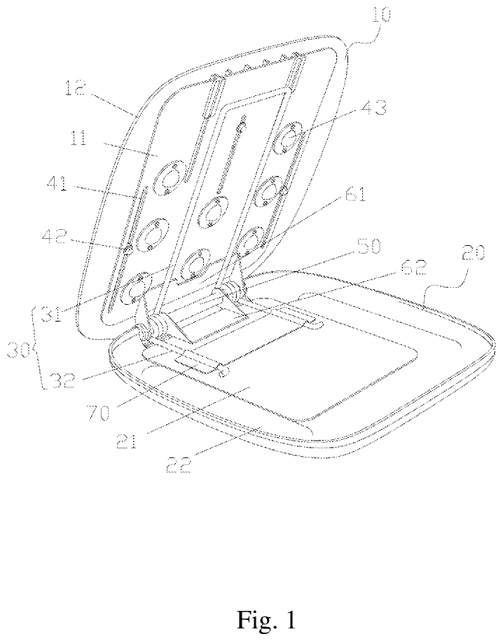

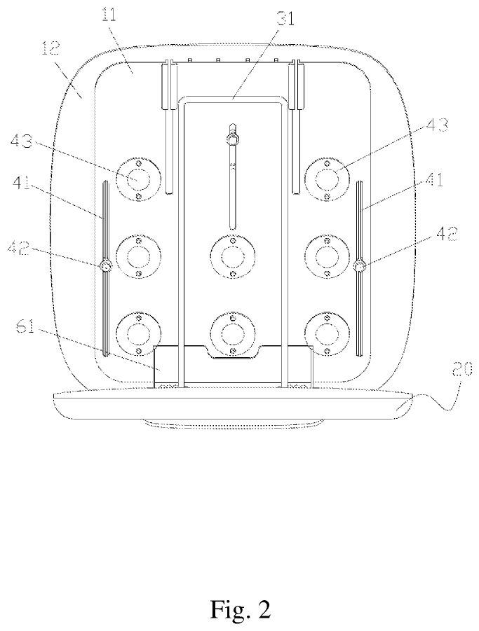

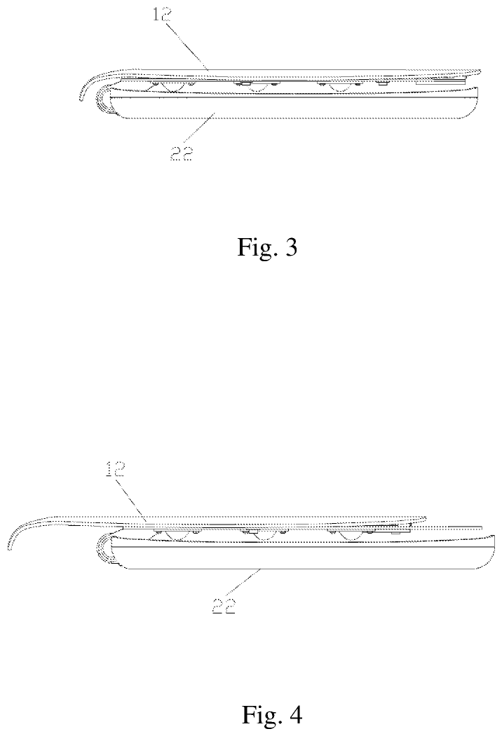

As shown in FIG. 1 to FIG. 4, the invention provides a lifting seat cushion, which includes an upper cushion assembly 10, a lower cushion assembly 20, an elastic member 30 and an adjustment structure. One end of the upper cushion assembly 10 and one end of the lower cushion assembly 20 can be rotatably connected. The elastic member 30 is arranged between the upper cushion assembly 10 and the lower cushion assembly 20. The elastic member 30 is used to support the upper cushion assembly 10 and the lower cushion assembly 20, so that the upper cushion assembly 10 and the lower cushion assembly 20 can be in the open state at the initial state. Among them, the upper cushion assembly 10 can be hinged with the lower cushion assembly 20 to realize the relative rotation of the two. One end of the elastic member 30, such as a wrap spring, can be connected to the upper cushion assembly 10 and the other end of the wrap spring can be connected to the lower cushion assembly 20 to realize the relative rotation of the two. In this embodiment, the upper cushion assembly 10 and the lower cushion assembly 20 rotate relative to each other to have an open state and a closed state. The elastic member 30 is in a compressed state when it is in a closed state. The elastic force of the elastic member 30 can be used to make the lifting seat cushion in an open state. By adjusting the adjustment structure, the torque of the upper cushion assembly 10 to the elastic member 30 in the open state and the closed state is different. The torque difference to the elastic member 30 can be realized by changing the pressure on the upper cushion assembly 10, or by changing the action point of the upper cushion assembly 10 relative to the elastic member 30.

Specifically, when using the above-mentioned lifting seat cushion, before the user sits down, the cushion is in the open state, and the upper cushion assembly 10 is used to slow down the trunk falling with the extended elastic member under the cushion. Because the user's trunk gravity is greater than the elasticity of the elastic member 30, the user can slowly sit down and close the upper cushion assembly 10 and the lower cushion assembly 20. Upon the user standing up, the adjustment structure changes the torque of the upper cushion assembly 10 to the elastic member 30, specifically, the torque can be smaller than the tension of the elastic member 30, so that the upper cushion assembly 10 can rebound, so that the user can complete the rising action without using his muscle force or other external forces. The lifting seat cushion can meet the needs of the elderly and physical impaired individuals to perform sit-to-stand actions, and reduce the risk of falling injury in the process of sitting down.

Specifically, the upper cushion assembly 10 includes the upper plate 11 and the upper cushion 12. The upper plate 11 has a first end and a second end which are relatively arranged. The first end of the upper plate 11 and the lower cushion assembly 20 can be rotatably connected. The elastic member 30 is arranged between the upper plate 11 and the lower cushion assembly 20. The upper cushion 12 is arranged on the side which is far away from the lower cushion assembly 20 of the upper plate 11, and the upper cushion 12 can be slid between the first end and the second end of the upper plate 11. Through the adjustment structure, the torque of the upper cushion 12 to the elastic member 30 can be changed by sliding the upper cushion 12 relative to the upper plate 11. Specifically, when the upper cushion 12 slides from the second end of the upper plate 11 to the first end, the torque of the upper cushion 12 to the elastic member 30 decreases gradually. When sliding to the position that overcomes the user's trunk weight gravity, the upper cushion assembly 10 can rotate towards the open position, and the user can get up with the elastic torque. When the user needs to sit down, the upper cushion 12 is moved from the first end of the upper plate 11 to the second end to increase the torque of gravity and overcome the elastic torque to complete the closure of the upper cushion assembly 10 and the upper cushion assembly 20.

The adjustment structure can solve the problem of difficulty in getting up caused by the lack of lifting thrust of the existing lifting seat cushion when the user gets up. In addition, the movement of the upper cushion 12 are consistent with the user's leaning forward and bending knees on rising and sitting body movements. Shifting the upper cushion 12 forward, reduces the torque of gravity to the elastic member 30, the extension of the elastic member opens up the upper cushion assembly, generates the up lifting thrust, and then complete the standing up movement.

Specifically, the adjustment structure includes a guide slot 41 and a guide rod 42, wherein the guide slot 41 is arranged on the upper plate 11, and the guide slot 41 extends along the first end to the second end of the upper plate 11, one end of the guide rod 42 is connected with the upper cushion 12, and the other end of the guide rod 42 can be slidably arranged in the guide slot 41. The upper cushion 12 can slide back and forth with respect to the upper plate 11 through the guide slot 41 and the guide rod 42.

In this embodiment, the adjustment structure includes a plurality of guide slots 41 and a plurality of guide rods 42, wherein a plurality of guide slots 41 are arranged on the upper plate 11 in parallel with each other, and a plurality of guide slots 41 and a plurality of guide rods 42 are arranged one by one correspondingly. By setting a plurality of guide slots 41 and a plurality of guide rods 42, the upper cushion 12 can slide relatively stably on the upper plate 11, the stability of the movement of the upper cushion 12 can be ensured, and the safety of the user can be ensured. Moreover, by threading the guide rod 42 into the guide slots 41, the sliding stroke of the upper cushion 12 can be limited, and the upper cushion 12 can only slide within the length range of the guide slots 41.

Specifically, the adjustment structure also includes a rolling element 43, which is arranged between the upper plate 11 and the upper cushion 12. The rolling element 43 is used to reduce the friction force of the upper cushion 12 sliding on the upper plate 11. Specifically, the rolling element 43 can be a spherical roller, a plastic sliding plate and other components. By setting the rolling element 43, the upper cushion 12 can slide more smoothly and stably.

Wherein, the elastic member 30 can be a wrap spring, a spring or an air spring. In this embodiment, the elastic member 30 is set as a wrap spring, the wrap spring has a relatively set upper arm 31 and a lower arm 32, the upper cushion assembly 10 and the lower cushion assembly 20 are connected by a rotating shaft 50, the wrap spring is penetrated on the rotating shaft 50, the upper arm 31 is butted with the upper cushion assembly 10, and the lower arm 32 is butted with the lower cushion assembly 20. Specifically, the upper arm 31 is butted with the upper plate 11 to apply elastic force to the upper cushion assembly 10 and the lower cushion assembly 20 through the wrap spring.

Wherein, the lower cushion assembly 20 includes the lower plate 21 and the lower cushion 22, the lower plate 21 or the lower cushion 22 is connected with the first end of the upper plate 11 through the rotating shaft 50, the lower cushion 22 is fixedly connected with the lower plate 21, and the lower cushion 22 is located on the side of the lower plate 21 far away from the upper plate 11. Among them, the lower plate 21 and the upper cushion 22 can be an integrated structure or a split structure. In this embodiment, the lower plate 21 and the upper cushion 22 are set as a split structure, which can make the materials of the two different to meet the requirements of comfort and connection strength respectively.

As shown in FIG. 1, the lifting seat cushion also includes an upper connecting piece 61 and a lower connecting piece 62. The upper connecting piece 61 includes an interconnected upper connecting plate and an upper rotating arm with holes. The upper rotating arm is located on both sides of the upper connecting plate, and the upper connecting plate is connected with the first end of the upper plate 11. The lower connecting member 62 includes an interconnected lower connecting plate and a lower rotating arm with holes. The lower rotating arm is located on both sides of the lower connecting plate, and the lower connecting plate is connected with the lower plate 21. The rotating shaft 50 is arranged on the upper cushion 22, and the rotating shaft 50 is penetrated into the holes on the upper rotating arm, the holes on the lower rotating arm and the shaft holes of the wrap spring to rotatably connect the upper plate 11 and the lower plate 21. The connection strength can be improved by setting the upper connector 61 and the lower connector 62, and it is convenient for the production and installation of the device. Wherein, the upper connector 61 and the upper plate 11 can be an integral structure, and the lower connector 62 and the lower plate 21 can be an integral structure.

In this embodiment, the lifting seat cushion also includes a fixing plate 70, which is connected with the lower plate 21. The fixing plate 70 has a avoidance groove, the lower arm 32 is penetrated in the avoidance groove, and the lower arm 32 is fixed on the lower plate 21 through the fixing plate 70. The wrap spring can be fixed by setting a fixing plate 70, so as to avoid shaking when the wrap spring rises or sits down. Specifically, the fixed plate 70 can be connected with the lower plate 21 by stamping.

Through the lifting assisted seat cushion provided in this embodiment, the user can use the trunk lean forward motion to shift the upper cushion 12 forward while sitting on the seat, so as to reduce the trunk weight torque to the elastic member. When the downward trunk weight torque is less than the torque of the preloaded wrap spring, the upper cushion 12 will open under the action of the wrap spring to provide the lifting thrust needed for standing up. At the initial stage of standing up, the body lean forward movement slides the seat cushion forward and bend the knee joint move foot backward. These movements shortens the distance between the center of gravity of the trunk weight and the standing foot and reduces the muscle force required by the legs to stand up against the couple at the initial stage of sitting up.

When sitting down, the upper cushion 12 in the open state contacts the body in advance and bears part of the body's sitting weight to relieve the muscle burden of the legs and help the user to sit down independently. In the process of sitting down, the upper cushion 12 slides to the rear naturally to increase the downforce torque. When the downforce torque is greater than the elastic torque, the upper and lower cushions close naturally. The lifting seat cushion not only assist the user to sit down, but also help the user to stand up and reduce the risk of falling and injury when the user sits down.

It should be understood by those who have general knowledge in the technical field of the invention that the discussion of any of the above embodiments is only illustrative and not intended to imply that the scope of the disclosure (including the scope of patent application) is limited to these examples; under the idea of the invention, the above embodiments or the technical features in different embodiments can also be combined and exist as above Many other changes in different aspects of this creation are described, which are not provided in detail for the sake of brevity. Therefore, any omission, modification, equivalent replacement, improvement, etc. made within the spirit and principles of this creation shall be included in the scope of protection of this creation.

On the whole, the technical means disclosed in this creation are not only unprecedented, but also can achieve the expected purpose and effect, so it has both novelty and progress. It is truly the new type as mentioned in the patent law. In terms of its overall structure, it has met the legal requirements of the patent law. Therefore, a new patent application is filed in accordance with the law.

However, the above is only a better example of the invention, which can not be used to limit the scope of the invention. That is to say, any equivalent changes and modifications made in accordance with the scope of the patent application for the invention and the contents of the specification shall still be within the scope of the invention patent.

The following call-out list of elements in the drawing can be a useful guide when referencing the elements of the drawing figures:
10 upper cushion assembly
11 upper board
12 upper cushion
20 lower cushion assembly
21 lower plate
22 lower cushion
30 elastic member
31 upper arm
32 lower arm
41 guide slot
42 guide rod
43 rotating element
50 rotating shaft
61 upper connection
62 lower connection
70 fixed plate

What is claimed is:

1. An apparatus to assist an individual standing up from a chair or a seat cushion, comprises:
an upper cushion assembly (10),
a lower cushion assembly (20),
an elastic member (30) and
an adjustment structure;
one end of said upper cushion assembly (10) is rotatably connected with one end of said lower cushion assembly (20), and said elastic member (30) is arranged between said upper cushion assembly (10) and said lower cushion assembly (20), wherein said upper cushion assembly (10) and said lower cushion assembly (20) rotate relative to each other to have an open state and a closed state;
said elastic member (30) is in a compressed state in the closed state, and said adjustment structure is used to reduce the torque of said upper cushion assembly (10) on the elastic member (30) to open said upper cushion assembly (10) and generate lifting thrust from the extending of said elastic member (30).

2. The apparatus as recited in claim 1, wherein said upper cushion assembly (10) comprises:
an upper plate (11) and an upper cushion (12);
said upper plate (11) has a first end and a second end which are relatively arranged, the first end of the upper plate (11) is rotatably connected with the lower cushion assembly (20);
said elastic member (30) is arranged between said upper plate (11) and said lower cushion assembly (20);
said upper cushion (12) is arranged on the side of the upper plate (11) far away from said lower cushion assembly (20), and said upper cushion (12) can slide between the first end and the second end relative to said upper plate (11).

3. The apparatus as recited in claim 2, wherein said adjustment structure comprises:
a guide slot (41) and a guide rod (42);
said guide slot (41) is arranged on said upper plate (11), and said guide slot (41) extends from the first end to the second end of said upper plate (11);
one end of said guide rod (42) is connected to said upper cushion (12), and the other end of said guide rod (42) is slidably arranged in said guide slot (41).

4. The apparatus as recited in claim 3, wherein said adjustment structure comprises a plurality of said guide slots (41) and a plurality of said guide rods (42), wherein the plurality of said guide slots (41) are arranged on said upper plate (11) in parallel with each other, and the plurality of said guide slots (41) are arranged one by one with the plurality of said guide rods (42).

5. The apparatus as recited in claim 2, wherein said adjustment structure comprises:
a rolling element (43) arranged between said upper plate (11) and said upper cushion (12), which is used to reduce the friction force of said upper cushion (12) sliding on said upper plate (11).

6. The apparatus as recited in claim 2, wherein said elastic member (30) comprises:
a wrap spring, said wrap spring has a relatively arranged upper arm (31) and a lower arm (32);
said upper cushion assembly (10) and said lower cushion assembly (20) are connected by a rotating shaft (50), said rotating shaft is threaded through said wrap spring, and said upper arm (31) is butted with said upper cushion assembly (10), and said lower arm (32) is butted with said lower cushion assembly (20).

7. The apparatus as recited in claim 6, wherein said lower cushion assembly (20) comprises:
a lower plate (21) and a lower cushion (22);
said lower plate (21) or said lower cushion (22) is connected to the first end of said upper plate (11) through a rotating shaft (50), said lower cushion (22) is fixedly connected with said lower plate (21) and on the side of the lower plate (21) away from the upper plate (11).

8. The apparatus as recited in claim 7, wherein said lifting seat comprises:
an upper connecting piece (61) and a lower connecting piece (62);
said upper connecting piece (61) includes an interconnected upper connecting plate and an upper rotating arm with holes, said upper rotating arm is located on both sides of said upper connecting plate, and the upper connecting plate is connected with the first end of the upper plate (11);
said lower connecting piece (62) comprises: an interconnected lower connecting plate and a lower rotating arm with holes, said lower rotating arm is located on both sides of said lower connecting plate, said lower connecting plate is connected with said lower plate (21);
said rotating shaft (50) is penetrated into the holes on said upper rotating arm, the holes on said lower rotating arm and said shaft holes of said wrap spring to connect said upper plate (11) and said lower plate (21) rotatable connection.

9. The apparatus as recited in claim 7, wherein said lifting seat cushion also includes a fixing plate (70), said fixing plate (70) is connected with said lower plate (21), said fixing plate (70) is provided with a avoidance groove, said lower arm (32) is penetrated in the avoidance groove, and said lower arm (32) is fixed at the lower part through said fixing plate (70) on said lower plate (21).

10. The apparatus as recited in claim 7, wherein said lower plate (21) and said lower cushion (22) are of a separate structure, and said material of said lower plate (21) is different from that of said lower cushion (22).
